(19) United States
(12) Patent Application Publication
(10) Pub. No.: US 2018/0285965 A1
(43) Pub. Date: Oct. 4, 2018

(54) MULTI-DIMENSIONAL FONT SPACE MAPPING AND PRESENTATION

(71) Applicant: Monotype Imaging Inc., Woburn, MA (US)

(72) Inventors: Sampo Juhani Kaasila, Portsmouth, NH (US); Chiranjeev Ghai, New Dehli (IN); Anand Vijay, Madhya Pradesh (IN)

(21) Appl. No.: 15/943,311

(22) Filed: Apr. 2, 2018

Related U.S. Application Data
(60) Provisional application No. 62/479,979, filed on Mar. 31, 2017.

(51) Int. Cl. G06Q 30/06; G06Q 30/02; G06F 15/18

(52) U.S. Cl. CPC G06Q 30/0643; G06F 15/18; G06Q 30/0203; G06Q 30/0625

(57) ABSTRACT

A system includes a computing device that includes a memory configured to store instructions. The system also includes a processor to execute the instructions to perform operations that include receiving data representing a plurality of items, at least two items of the plurality of items being different. Operations also include representing each of the items in an n-dimensional space, the n-dimensional space being defined by at least one of a first dimension representing an item category of the plurality of items, a second dimension representing an item attribute of the plurality of items, and the first dimension and the second dimension. Operations also include presenting at least a two-dimensional graphical representation of a portion of the plurality of items, the at least two-dimensional graphical representation reflecting at least one of the first dimension, the second dimension, and the first dimension and the second dimension.

### CROSS-REFERENCE TO RELATED APPLICATIONS

This application claims priority under 35 U.S.C. § 119(e)(1) to U.S. Provisional Application No. 62/479,979 filed Mar. 31, 2017. The contents of this application is hereby incorporated by reference in its entirety.

### BACKGROUND

This description relates to mapping a multi-dimensional font space, or type of product space, into a visually realizable representation (e.g., into two or three dimensions) for graphical presentation. Along with presenting a large number of fonts (or other products) in an easily comprehensible representation, end users can easily navigate the representation to identify, select, etc. fonts or other products of interest.

Proportional to the astronomical growth of available text content, for example via the Internet, the demand to express such content continues to grow. Similar to the variety of products provided by online stores; content authors, publishers, graphic designers, etc. have grown accustomed to having a vast variety of fonts to present textual content. However, the virtual explosion in the sheer number of usable fonts can become overwhelming and saturate an individual attempting to find and select a particular font. Similar situations occur when individuals attempt to identify other types of products (e.g., shoes) of interest. Faced with such an overabundance of information, decision-making abilities can be hampered, causing the individual to become frustrated and potentially give up on finding a font, other type of product, etc.

### SUMMARY

The systems and techniques described can aid individuals such as designers (e.g., website designers) in efficiently finding and selecting fonts that may resonate with the person. By employing dimension-reducing and graphical techniques, a vast collection of fonts (e.g., tens of thousands, hundreds of thousands) may be presented to an individual for relatively easy inspection. Such a presentation may assist the individual in a variety of tasks such as identifying one or more fonts to potentially license, taking inventory of a font library (e.g., previously licensed by the individual or an entity), etc. Through the use of color and/or other types of graphics, the fonts may be classified, e.g., as being similar, to further assist individuals in quickly identifying, selecting, etc. one or more fonts of interest. Such graphical techniques may be employed for various products, services, etc. For example, a large variety of shoes may similarly be characterized and presented in a graphic representation to allow individuals to quickly identify a shoe design without having to endlessly scroll through numerous pages of one or more web sites.

In one aspect, a computing device implemented method includes receiving data representing a plurality of items, at least two items of the plurality of items being different. The method also includes representing each of the items in an n-dimensional space. The n-dimensional space is defined by at least one of a first dimension representing an item category of the plurality of items, a second dimension representing an item attribute of the plurality of items, and the first dimension and the second dimension. The method also includes presenting at least a two-dimensional graphical representation of a portion of the plurality of items, the at least two-dimensional graphical representation reflecting at least one of the first dimension, the second dimension, and the first dimension and the second dimension.

Implementations may include one or more of the following features. The n-dimensional space may be defined by a third dimension representing similarity of pairs of items included in the plurality of items. Color may be used to reflect at least one of the first dimension, the second dimension, and the first dimension and the second dimension in the at least two-dimensional graphical representation. The plurality of items may be a plurality of fonts. The plurality of items may be a plurality of products. The similarity of the pairs of items may be determined from item features and survey data. The item category of the plurality of items may be determined by machine learning. The item attribute of the plurality of items may be determined by machine learning. A dimensionality reduction process may be used to present the two-dimensional graphical representation of the portion of the plurality of items. The first dimension and the third dimension may be represented in the two-dimensional graphical representation, the third dimension being represented in color. The first dimension and the second dimension may be represented in the two-dimensional graphical representation, the first dimension being represented color. The two-dimensional graphical representation may be visually expandable. The portion of the plurality of items may include all of the plurality of items based on the two-dimensional graphical representation being visually expanded. The portion of the plurality of items may include a subset of the plurality of items based on the two-dimensional graphical representation being visually compressed. The subset of the plurality of items may include items most frequently requested from users.

A system includes a computing device that includes a memory configured to store instructions. The system also includes a processor to execute the instructions to perform operations that include receiving data representing a plurality of items, at least two items of the plurality of items being different. Operations also include representing each of the items in an n-dimensional space, the n-dimensional space being defined by at least one of a first dimension representing an item category of the plurality of items, a second dimension representing an item attribute of the plurality of items, and the first dimension and the second dimension. Operations also include presenting at least a two-dimensional graphical representation of a portion of the plurality of items, the at least two-dimensional graphical representation reflecting at least one of the first dimension, the second dimension, and the first dimension and the second dimension.

Implementations may include one or more of the following features. The n-dimensional space may be defined by a third dimension representing similarity of pairs of items included in the plurality of items. Color may be used to reflect at least one of the first dimension, the second dimension, and the first dimension and the second dimension in the at least two-dimensional graphical representation. The plurality of items may be a plurality of fonts. The plurality of items may be a plurality of products. The similarity of the pairs of items may be determined from item features and survey data. The item category of the plurality of items may be determined by machine learning. The item attribute of the plurality of items may be determined by machine learning. A dimensionality reduction process may be used to present the two-dimensional graphical representation of the portion of the plurality of items. The first dimension and the third dimension may be represented in the two-dimensional graphical representation, the third dimension being represented in color. The first dimension and the second dimension may be represented in the two-dimensional graphical representation, the first dimension being represented color. The two-dimensional graphical representation may be visually expandable. The portion of the plurality of items may include all of the plurality of items based on the two-dimensional graphical representation being visually expanded. The portion of the plurality of items may include a subset of the plurality of items based on the two-dimensional graphical representation being visually compressed. The subset of the plurality of items may include items most frequently requested from users.

In another aspect, one or more computer readable media storing instructions that are executable by a processing device, and upon such execution cause the processing device to perform operations that include receiving data representing a plurality of items, at least two items of the plurality of items being different. Operations also include representing each of the items in an n-dimensional space, the n-dimensional space being defined by at least one of a first dimension representing an item category of the plurality of items, a second dimension representing an item attribute of the plurality of items, and the first dimension and the second dimension. Operations also include presenting at least a two-dimensional graphical representation of a portion of the plurality of items, the at least two-dimensional graphical representation reflecting at least one of the first dimension, the second dimension, and the first dimension and the second dimension.

Implementations may include one or more of the following features. The n-dimensional space may be defined by a third dimension representing similarity of pairs of items included in the plurality of items. Color may be used to reflect at least one of the first dimension, the second dimension, and the first dimension and the second dimension in the at least two-dimensional graphical representation. The plurality of items may be a plurality of fonts. The plurality of items may be a plurality of products. The similarity of the pairs of items may be determined from item features and survey data. The item category of the plurality of items may be determined by machine learning. The item attribute of the plurality of items may be determined by machine learning. A dimensionality reduction process may be used to present the two-dimensional graphical representation of the portion of the plurality of items. The first dimension and the third dimension may be represented in the two-dimensional graphical representation, the third dimension being represented in color. The first dimension and the second dimension may be represented in the two-dimensional graphical representation, the first dimension being represented color. The two-dimensional graphical representation may be visually expandable. The portion of the plurality of items may include all of the plurality of items based on the two-dimensional graphical representation being visually expanded. The portion of the plurality of items may include a subset of the plurality of items based on the two-dimensional graphical representation being visually compressed. The subset of the plurality of items may include items most frequently requested from users.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a smartphone presenting textual content in a font.

FIG. 2 illustrates a series of fonts presented on a computer display.

FIG. 3 is a block diagram of a network environment including a font service provider that manages the presentation of fonts for end users.

FIG. 4 is a block diagram of a font service provider.

FIGS. 5, 6, 7, 8, 9, and 10 illustrate interfaces for presenting a vast collection of user-selectable fonts in a single graphical representation.

FIGS. 11, 12, and 13 illustrates executable instructions reducing dimensionality for presenting fonts.

FIG. 14 is a flowchart of operations of a font presenter executed at a font service provider.

FIG. 15 illustrates an example of a computing device and a mobile computing device that can be used to implement the techniques described here.

### DETAILED DESCRIPTION

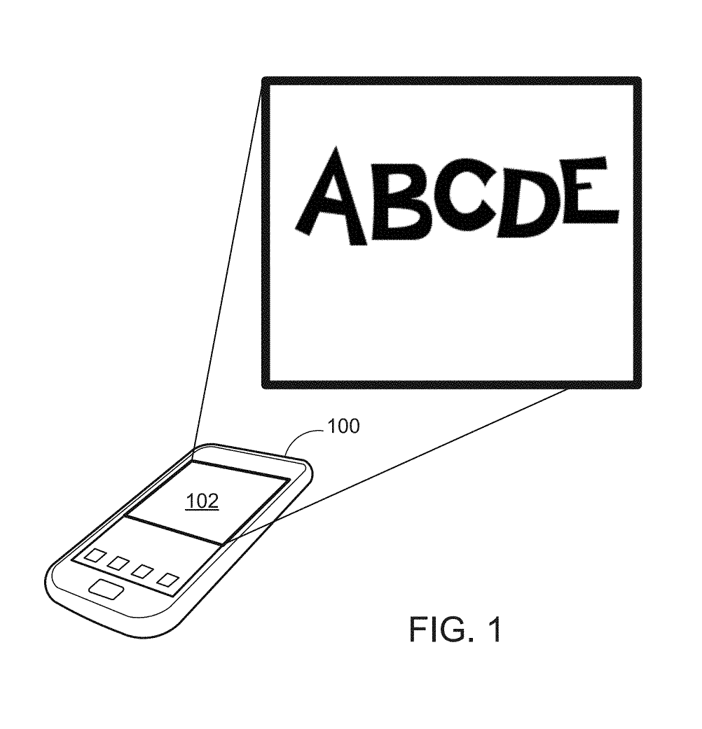

Referring to FIG. 1 a computing device (e.g., a mobile smartphone 100) includes a display 102 that allows user to view (and in some cases create, edit, etc.) various types of content such as text, via one more applications. Along with presenting different content from a variety of sources (e.g., Internet sites), browsers and other types of applications (e.g., word processors) may use different types of fonts to present a desired effect. For example, web assets (e.g., web pages, web sites, web based advertisements, etc.) may be developed that use particular fonts to quickly catch the attention of a viewer. With an ever-increasing number of fonts at a user's disposal (e.g., for web asset development, adjusting presented text, etc.), selecting an appropriate font for the project at hand could turn into an increasingly time-consuming task. To reduce such a potential time sink, one or more techniques may be implemented to present available fonts to a user (e.g., for subscription, licensing, etc.). By graphically presenting a large number of available fonts (and potentially all available fonts), one or more fonts may be relatively quickly identified by the individual. Further, by characterizing the fonts, e.g., by identifying similarities of the fonts, the individual may be able to visually navigate a single graphical representation (that represents all the fonts) to identify a subset of fonts that are of interest. In the illustrated example, a portion of the display 102 presents a string of capital characters (i.e., “A B C D E”) in a font that has visual characteristics that could be considered as projecting a positive connotation. The designer of a webpage (that includes this text) may have selected this particular font such that the web asset conveys such a feeling. To select this particular font, the designer may have reviewed a large number of potential candidate fonts (e.g., hundreds, thousands, etc.) in this particular genre. Reviewing fonts that convey an opposite feeling (e.g., sadness) may have also been done to assist the designer with arriving at a font selection, which would have further increased the number of fonts to review.

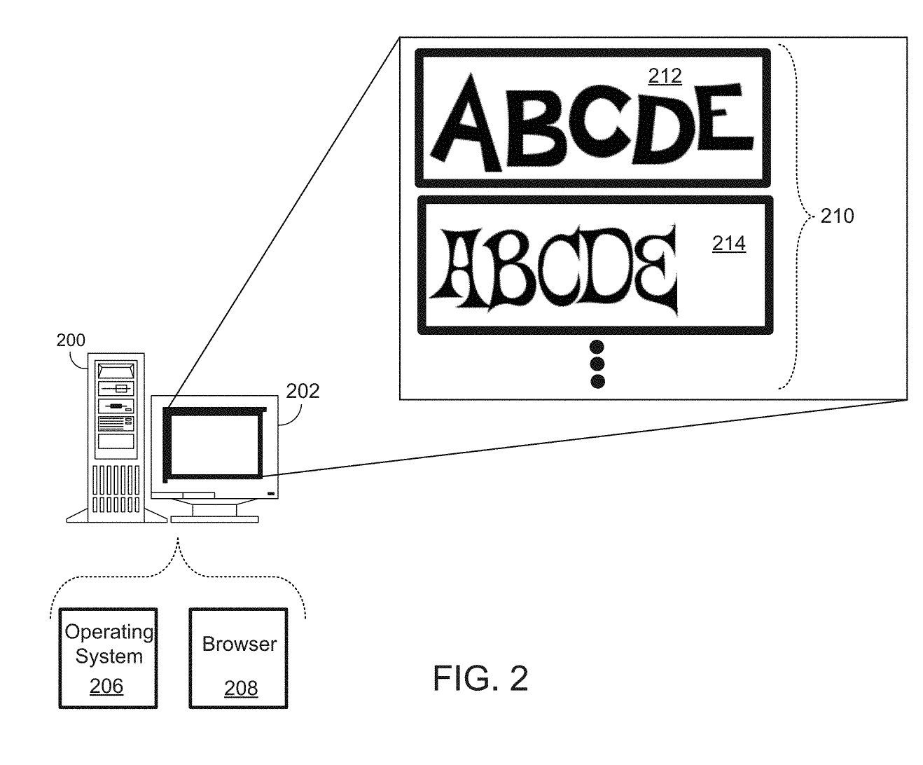

Referring to FIG. 2, a computer system 200 used for asset development (e.g., website development) is shown that includes a display 202 presenting a collection of selectable fonts. To present this information, the computer system 200 includes an operating system 206 and executes a browser 208 that exchanges information with a variety of data sources (e.g., the one or more sources that provide the presented font collections). In this illustration, a font collection 210 is show in which the first two selectable fonts are presented, and the initial five English letters are used to display each of the fonts. Here, the collection 210 includes selectable fonts that convey a positive connotation and includes the font presented by the smartphone 100 in FIG. 1 (i.e., font 212). A second font 214 is also presented within the collection of positive fonts 210. The collection 210 includes other fonts that are presented in a linear manner beneath fonts 212 and 214. Presented in such a manner, a considerable amount of time is needed for the designer to review each font. Further, to compare and contrast the members of the presented collection 210 (e.g., with other font collections), considerable time would be needed to present and review the fonts included in these other collections. As such, a designer may grow frustrated and hastily select a font before gaining a full appreciation of the all the available fonts. By presenting a single representation (or a few representations) of the vast number of available fonts, the designer can quickly navigate through a large variety of fonts, review fonts of particular interest, compare different types of fonts, etc. Along with reducing review time, the viewer is exposed to collections of fonts that are similar to a selected font (which may be of interest to the viewer). Presented the similar fonts, the viewer is able to consider different fonts for a current project, different upcoming projects, etc. and potentially select from these similar fonts.

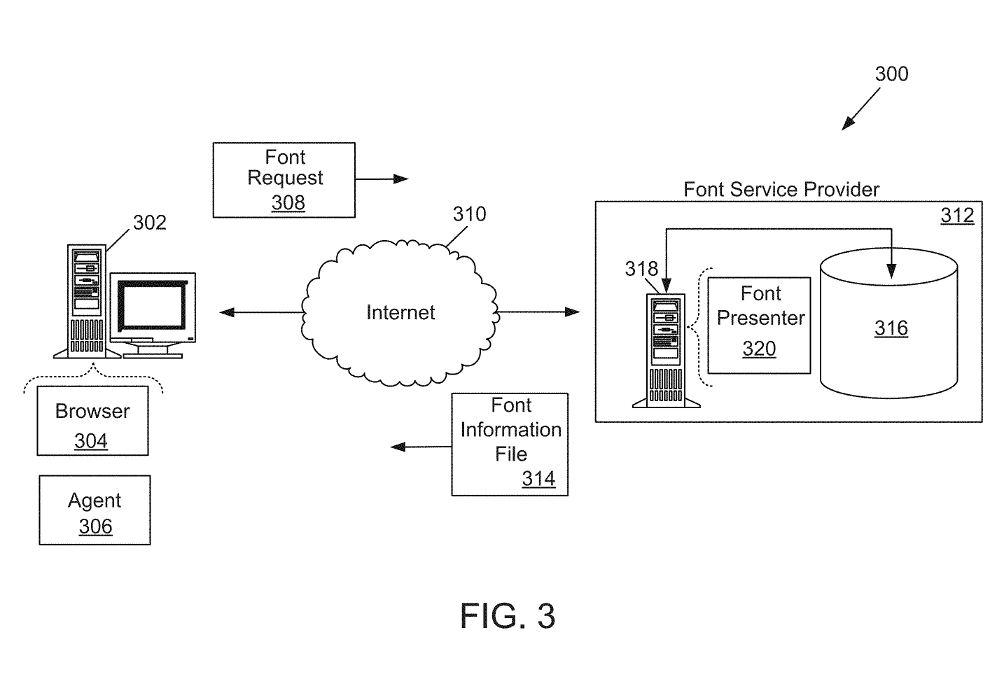

Referring to FIG. 3, a computing environment 300 is presented that includes a computer system 302 that a user may interact with (using a keyboard, a pointing device, etc.) for providing information about fonts of interest (e.g., selecting one or more fonts for a project). In this arrangement, a browser application 304 provides an interface with the user; however, other types of applications, processes, etc. may be employed. For example, the computer system 302 may execute a software agent 306 that may assist with collecting user indications of one or more fonts of interest. In some arrangements the software agent 306 may solicit information from a user (e.g., request font descriptions for a project, etc.), or collect information in an unsolicited manner (e.g., collect pointing device movements, click data, etc.). Such agents may also monitor user interactions for determining potential fonts of interest. Such agents can be considered a software module that is executable in a substantially autonomous manner. For example, upon being provided access to the computer system 302, a software agent may operate without considerable user interaction. By operating in a somewhat flexible manner, the software agent 306 can adaptively address font information needs. The software agent 306 may operate in a somewhat persistent manner to identify potential fonts of interest, etc. For example, the software agent 306 may execute in a substantially continuous manner.

Input from the user of the computer system 302 may also be used for selecting fonts of interest. For example, the user may initially request that a global view be provided of all available fonts. Upon reviewing the global data, the user may narrow the potential font selections to a particular font subset of interest. As such, multiple instances of user input may be provided for appropriately focusing a font search.

In the presented environment 300, a request 308 (e.g., containing user input, agent input, etc.) is sent over one or more networks (e.g., the Internet 310) to a font service provider 312 for processing and providing the requested information. For example, a global representation of a large number of fonts (or even all fonts associated with the font service provider 312) may be prepared, retrieved from storage (if previously prepared), etc. Once attained, one or more techniques may be implemented to provide the font information to the computer system 302 or other computing devices. For example, one or more files, such as a font information file 314, may be produced by the font service provider 312 and sent to the computer system 302. In some arrangements, the font service provider 312 may also provide the software agents to the computing devices in order to perform operations, such as collecting reaction information from the user (e.g., given a global representation of all fonts of the font service provider, which particular font type(s) appear to draw the user's interest, etc.). Agents delivered from the font service provider 312 may also provide other functions; for example, the agents may collect information to characterize the users, identify types of projects under develop by the user, etc. that may assist with providing font information to the user in the future.

To process, store, etc. information associated with fonts being provided to the computer system 302, the font service provider 312 typically needs access to one or more libraries of fonts, font information, etc. that may be stored locally or remotely. For example, font libraries and libraries of font information may be stored in a storage device 316 (e.g., one or more hard drives, CD-ROMs, etc.) on site. Being accessible by a server 318, the libraries may be used, along with information provided from software agents, computing devices, etc., to collect needed font information, etc. Illustrated as being stored in a single storage device 316, the font service provider 312 may also use numerous storage techniques and devices to retain collections of font information. Lists of fonts, lists of similar fonts, one or more metrics of fonts, etc. can also be stored (e.g., on the storage device 316) for later retrieval and use. The font service provider 312 may also access font information at separate locations as needed. For example, along with identifying fonts for the computer system 302, the server 318 may be used to collect needed information from one or more sources external to the font service provider 312 (e.g., via the Internet 310).

Along with collecting, processing and providing font information, the font service provider 312 may contribute other functions. For example, graphical representations of available fonts (e.g., global representations) may be produced to allow the users to quickly review a vast number of different fonts and assist them in quickly identifying fonts of interest. To aid the user in quickly grasping the differences of a large number of fonts (e.g., tens of thousands, hundreds of thousands), different type of graphical representations may be produced and provided to the computer system 302. For example, characteristics of each available font can be used to represent all the fonts in an n-dimensional font space. The data representing the fonts in this space can be processed to prepare a single graphical representation of the fonts. For example, one or more projections of the n-dimensional font space may be produced to allow a user to view all the fonts in a single two-dimensional graphical representation. Along with providing a single view of all the fonts, the user is able to quickly recognize similarities and differences among the fonts without needing to endlessly scroll through lists of sample fonts. To provide such functionally, the server 318 executes a font presenter 320, which, in general, can create a single graphical representation (or a few representations) that represents all the fonts associated with the font service provider 312 (e.g., being managed by the provider). The font presenter 320 may also provide other functionality such as preparing graphical representations of font libraries external to the font service provider 312. For example, font information such as current font subscriptions of a user, fonts currently stored at a user site (e.g., on the user's computer system 302), etc. may be provided (e.g., by a software agent such as the agent 306), retrieved by, etc. the font service manager 312. Proving graphical representation of the user's existing fonts, a user can quickly identify the current fonts in their collection and realize which fonts are missing. By viewing a combination of graphical representations that provide a view of their current font collection and the fonts available from the font service provider 312, user interest in other fonts along with font subscriptions may increase.

The environment 300 may utilize various types of architectures to provide this functionality. Further, while the environment 300 is described as providing graphical representations for a vast number of available fonts (from the font service provider 312), such representations may be produced for other types of items. For example, similar to being fonts; items may also be products (e.g., consumer goods such as shoes), for different types of services, etc. Similar to fonts, such representations would allow individuals (e.g., consumers) to quickly review vast collections and identify particular items of interest.

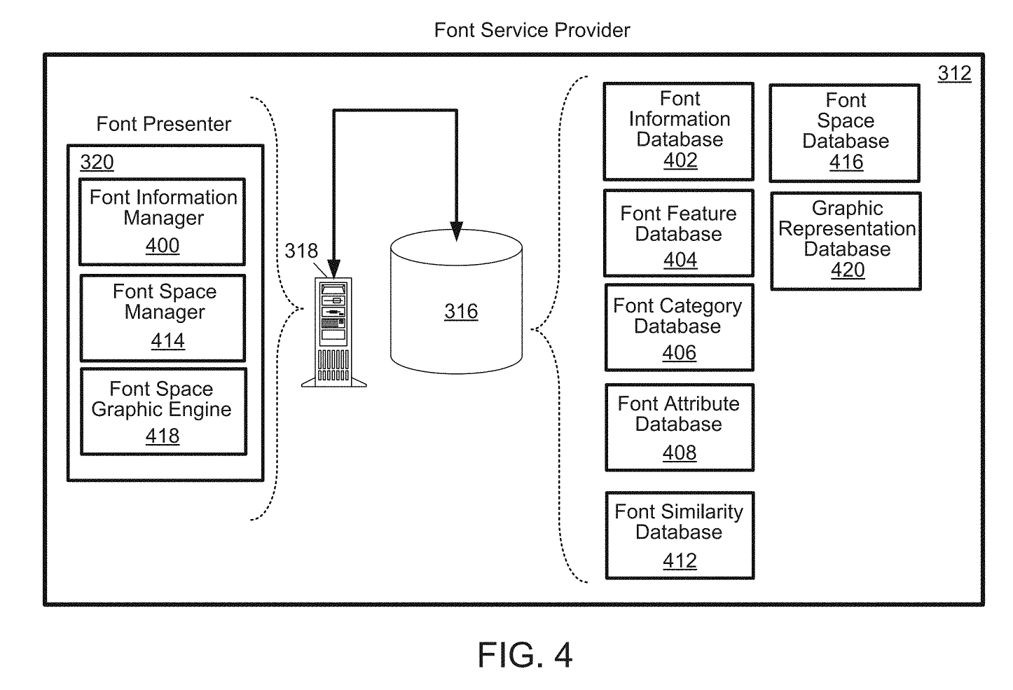

Referring to FIG. 4, the font presenter 320, which is executed by the server 318 at the font service provider 312, includes a number of modules. In this arrangement, the font presenter 320 includes a font information manager 400 that is capable of receiving data that represents a large collection of fonts. One or more techniques may be utilized for representing the font information. For example, to provide individuals (e.g., designers) with a global view of a large number of fonts (perhaps even all the fonts available at the font service provider 312), the collected font information may be represented in an n-dimensional font space. Once represented in this font space, various type of graphical representations of the space or subsets of the space can be created to provide global (or semi-global) views. For example, various types of two and three dimension representations (e.g., projections, etc.) may be created and provided to the end user for review.

Along with receiving the data representing fonts, the font information manager 400 can provide other types of functionality such as mapping data representing the fonts into an n-dimensional space. One or more type of dimensions, conventions, etc. can be defined for such font spaces. In one arrangement, features of each font, which individually or in combination uniquely describe the font, can be numerically represented. In some arrangements, a vector of features (e.g., thirty-two numerical values representing thirty-two features) is used to represent a font. Such features may be defined and numerically represented using various techniques (e.g., one or more machine learning systems), for example, as described in U.S. patent application Ser. No. 14/046,609, titled “Analyzing Font Similarity for Presentation,” filed on 4 Oct. 2013, which is incorporated by reference here in its entirety. Along with determining numerical values to represent respective features for each font (e.g., 32 features, 40 features, 50 features, etc.), the font information manager 400 may also provide other functions to compare fonts (e.g., by comparing corresponding features of the fonts). For example, techniques may be employed to measure and represent the similarity of two fonts. Such similarity measure and representation techniques are described in the above-identified U.S. patent application Ser. No. 14/046,609, titled “Analyzing Font Similarity for Presentation,” filed on 4 Oct. 2013, again, which is incorporated by reference here in its entirety.

Font categories is another potential dimension in the n-dimensional font space. In general, categories can be defined from the determined features of the fonts. Once the features are determined, one or more techniques can be used for categorizing the fonts that are represented by provided the features. For example, one or more forms of artificial intelligence, such as machine learning, can be employed such that a computing process or device may learn to categorize the font from the features of the font. Artificial intelligence techniques may also be used for determining features to represent fonts and to determine similarity among fonts (e.g., determine a similarity measure between two fonts). To provide this functionality, machine learning may employ techniques such as regression to estimate font similarities. Upon being trained, a learning machine may be capable of outputting one or more numerical values that represents one or more categories to which the font should be considered a member. Input to the trained learning machine may take one or more forms. In one arrangement, representations of the font itself may be provided to the trained learning machine (e.g., bitmaps of font characters). Numerical representations of the font may also be used as input to the learning machine. For example, particular features that uniquely describe each font may be provided to allow the learning machine to output a series of number values that represent which category or categories the font should be considered a member. For example, each output value may range 0-1.0 in which low values (e.g., 0.2) represent that the font should not be a member of the respective category (or categories) and higher values (e.g., 0.8, 1.0) represent that the membership should be granted. Arrangements for providing such categories are described in U.S. patent application Ser. No. 14/690,260, titled “Pairing Fonts for Presentations,” filed on 17 Apr. 2015, which is incorporated by reference here in its entirety. In some arrangements, each font may be associated with a single category, or, a font may be associated with multiple categories in another arrangement. In one arrangement, individual categories are identified by the machine learning system. Other techniques may also be employed; for example, predefined categories may be used. In one example, sixteen categories are identified from font features and each is given label that describes its font membership: (1) Italian Old Style Serif, (2) French Old Style Serif, (3) Dutch Old Style Serif, (4) Transitional Serif, (5) Modern Serif, (6) Clarendon Serif, (7) Slab Serif, (8) Geometric Sans Serif, (9) Grotesque Sans Serif, (10) Humanist Sans Serif, (11) Contemporary Humanist Sans Serif, (12) Humanist Sans Serif, (13) Informal Script, (14) Formal Script, (15) Black Letter, (16) Symbol, and (17) Display. In some arrangements, more or less categories may be defined to separate the fonts (for presentation). Also, other types of categories may be defined using the font features and/or other information sources. In some arrangements, other font category groups can be used that include some of these sixteen categories (listed above), or a group can be used that is absent these sixteen categories.

To manage the information being used by the font information manager 400, one or more structures, databases, etc. may be stored at the font service provider 312. In this illustration, a font information database 402 is stored at and can be accessed from the storage device 316. Once font features are determined, e.g., calculated by the font information manager 400, data represented the features can be stored in a font feature database 404 (that resides on the storage device 316). By storing the font features, data can be retrieved as needed for determining various quantities such as one or more dimensions of an n-dimensional font space. In a similar manner, data representing the font categories as determined by the font information manager 400 can also be stored on the storage device 316, e.g., in a font category database 406.

Other types of dimensions may also be defined for the n-dimensional font space; for example another dimension may represent a font attribute that is determined from one or more data sources. Such attributes may represent a physical characteristic of a font character; for example, some font characters may appear to have portions (e.g., letter stems, etc.) with narrow widths while other fonts can appear to have wider widths. As such, width can be considered an attribute of fonts and one or more conventions may be used to represent the different widths. For example, normalized on a scale from 0.0 to 1.0, values with larger values (e.g., 0.8) can be used to represent fonts with narrower widths and values at the lower portion of the scale can be used to represent fonts with wider widths. Similar to widths, other type of attributes may be defined to provide a dimension to the n-dimensional font space. One or more data sources may be used to define such attributes; for example, font feature data (e.g., a 50 element vector quantity for each font) may be used to define font attributes. Machine learning techniques may also be used for identifying attributes of a font. For example, provided a variety of different fonts, a machine learning system can develop a collection of attributes to define attributes to represent the fonts. Information from individuals (e.g., designers, potential font licensees, etc.) such as survey information may also be employed to define attributes. For one type of survey, individuals may be presented samples of two fonts (e.g., a font with narrow character portions, and a font with wide character portions) and then asked to describe the differences of the two fonts. By collecting responses from a number of individuals for a variety of font comparisons (e.g., 500 to 100,000 similarity questions), noticeable trends may be detectable to identify particular font attributes. For the illustrated system, thirty-three fonts attributes provide dimensions and can be used (e.g., selected from) to assist in viewing a large number of fonts. In this example, the font attributes include: (1) Weight, (2) Width, (3) Artistic, (4) Assertive, (5) Attention Grabbing, (6) Attractive, (7) Calm, (8) Casual, (9) Comic Book, (10) Compassionate, (11) Confident, (12) Cool, (13) Decorative, (14) Dramatic, (15) Elegant, (16) Exciting, (17) Feminine, (18) Friendly, (19) Graceful, (20) Happy, (21) Industrial, (22) Legible, (23) Modest, (24) Playful, (25) Poster, (26) Retro, (27) Romantic, (28) Sad, (29) Smooth, (30) Soft, (31) Techno, (32) Trustworthy, and (33) Youthful. Each attribute be considered as having an associated numerical range (e.g., normalized to values of 0.0 to 1.0) that employs a convention (e.g., the attribute is more present in fonts associated with lower values, and, the attribute is less reflected in fonts associated with higher values). Similar to using different attributes, in other arrangements different conventions may be employed to represent how pronounced the attribute is represented in a particular font. Similar to font features and categories; font attributes may be stored at the font service provider 312 (e.g., in the storage device 316), e.g., in a font attribute database 408. Similar to the other types of data, the attribute data may also be stored external from the font service provider 312, stored in a distributed manner (which may or may not include the font service provider 312), etc.

Along with defining different dimensions for the n-dimensional font space, one or more quantities may be calculated for presenting different aspects of the space. For example, similarities between two fonts may be used for presenting fonts having common features, contrasting features, etc. Such similarity measures can be defined in numerous manners; for example the difference between corresponding features of two fonts can be computed as a measure of similarity. Machine learning techniques, observations of individuals (e.g., survey data from designers, etc.), etc. may also assist in quantifying similarity. Techniques for computing similarity measures of fonts are described in U.S. patent application Ser. No. 14/046,609, titled “Analyzing Font Similarity for Presentation,” filed on 4 Oct. 2013, again, which is incorporated by reference here in its entirety. Grouping techniques may also be employed to assist in presenting fonts that may be considered similar or different. For example, techniques for grouping fonts may be employed as described in U.S. patent application Ser. No. 14/649,494, titled “Using Similarity for Grouping Fonts and Individuals for Recommendations,” filed on 23 Apr. 2015, which is incorporated by reference herein its entirety. Similar to the other types of data, font similarity data may be stored at the font service provider 316, for example in a font similarity database 412 on the storage device 316.

Once the dimensions for the n-dimensional font space have been determined, data representing the vast collection of fonts may be embedded into the space and prepared for presentation. In this example, the font presenter 320 includes a font space manager 414 that embeds fonts (e.g., managed by the font service provider 312) into the n-dimensional font space. Dimensions used to define the space can be determined by the font space manager 414, selected by a user, through a combination of manger determinations and user selections, etc. For example, based on a graphical representation of the font space desired by an end user (e.g., including font categories and font attributes), one or more dimensions may be selected for creating an appropriate presentation. Embedded in the n-dimensional font space, the font space manager 414 may store data representing the fonts as represented in the space. For each font, data may be stored for each possible dimension of the n-dimensional space. For example, stored data may quantify which category or categories that a font has been identified as being a member. Stored data may also represent a numerical value (from a range of values) to represent how each font embodies a particular font attribute. By storing this data in a font space database 416, the data may be assessed in a relatively quick manner to present a particular aspect of the font space. In this arrangement, the font presenter 320 includes a font space graphic engine 418 that accesses data in the font space database 416 and potentially other databases (or data sources) to prepare two or three dimensional representations of the n-dimensional font space. Mapping the n-dimensional font space onto a two-dimensional or three-dimensional representation may be executed by the font space graphic engine 418. Additionally, the created representation(s) may be stored at the font service provider, for example, in a graphic representation database 420. In some arrangements, one or more files may be created by the font space graphic engine 418, for example, to transport the produced graphic to the one or more end user devices (e.g., font information file 314 being sent to the computer system 302). The graphical representations may also be stored for later retrieval, for example, for further processing at the font service provider 312, one or more end user computing devices, etc.

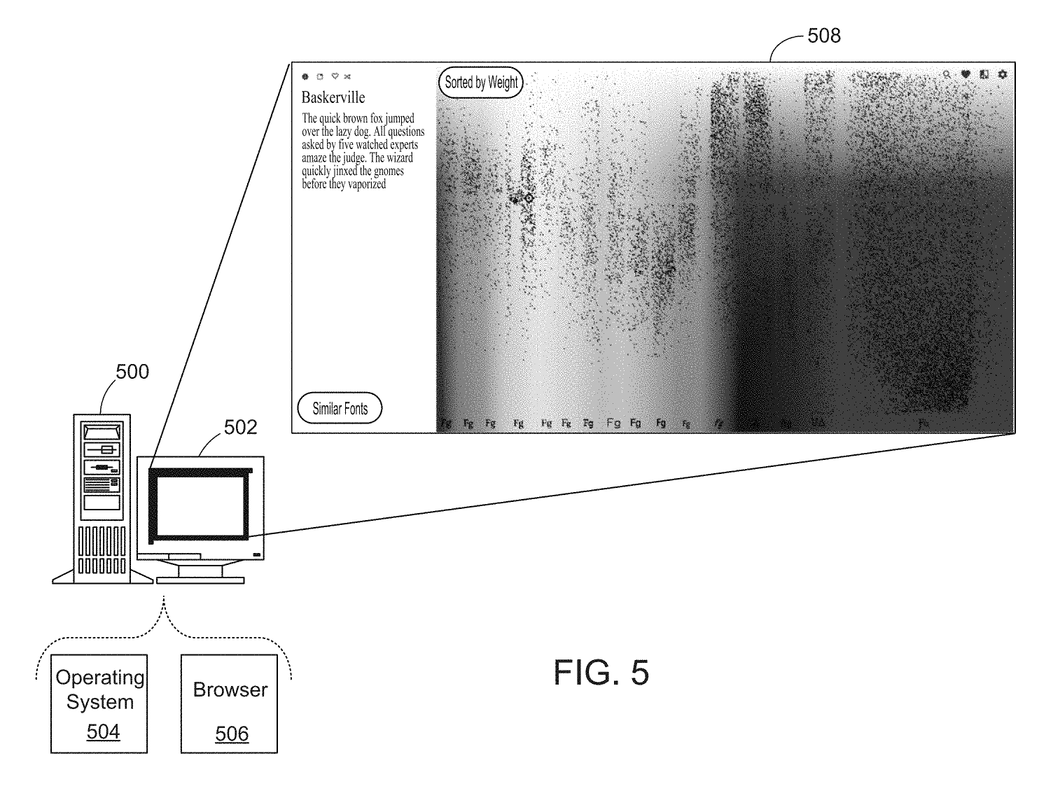

Referring to FIG. 5, one graphical representation is illustrated as being presented by a computer system 500 that includes a display 502 capable of showing colored content. Similar to the computing device 302; operations of the computing device 500 are governed by an operating system 504 and information can be exchanged with a font service provider via a browser 506 executed by the device. In this example, the user of the computing device has initiated a request to the font service provider 312 for the graphical representation. Presented in a graphical interface 508, the end user is quickly able to comprehend the vast number of fonts being graphically represented. By employing a spectrum of colors, the viewer is able to visually recognize how the different types of fonts are separated on the interface without getting overwhelmed by a seemingly endless list of fonts. Further, by employing a color scheme to represent one dimension and the horizontal axis and the vertical axis to represent other dimensions of the font space, a large number of fonts (e.g., all the fonts managed by a font service provider) can be represented on a single three-dimensional representation that is viewable without considerable adjustments or manipulations by the end user.

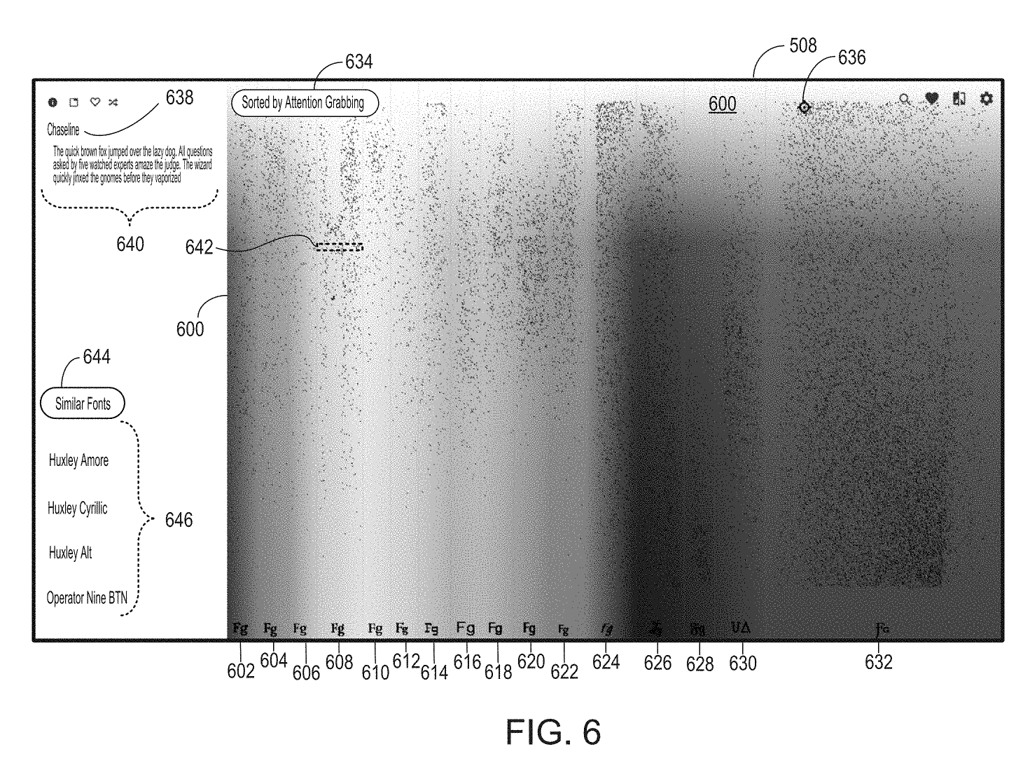

Referring to FIG. 6, an enlarged view of the graphical interface 508 is presented that displays one representation of the n-dimensional font space. The interface 508 includes a chart 600 that presents font categories along the horizontal axis and a range of numerical values of a user-selected font attribute along the vertical axis. In this example, sixteen categories are represented along the horizontal axis: Italian Old Style Serif (602), French Old Style Serif (604), Dutch Old Style Serif (606), Transitional Serif (608), Modern Serif (610), Clarendon Serif (612), Slab Serif (614), Geometric Sans Serif (616), Grotesque Sans Serif (618), Contemporary Humanist Sans Serif (620), Humanist Sans Serif (622), Informal Script (624), Formal Script (626), Black Letter (628), Symbol (630), and Display (632). As indicated in label 634, an attribute titled “Attention Grabbing” has been selected by the end user. Such a selection can be made from a drop down menu being presented to the end user by the interface 508 (as provided by a browser being executed by the user's computing device). For the convention being employed by the chart 600, less attention grabbing fonts are represented by data points moving up the chart and more attention grabbing fonts are represented by data points moving down the chart. In this example, as denoted with graphic 636, the end user can select a font located in Display category 632 towards the upper boundary of the chart. Once selected, a title 638 of the selected font along with a sample use case 640 of the selected font is presented in the interface 508 (adjacent to the chart 600). As provided by the title 638 and sample 640, the selected font is certainly less than attention grabbing, which explains its upper position along the vertical axis for the selected font attribute (again, font represented higher on the vertical axis are less reflective of the font attribute compared to fonts positioned lower on the vertical axis). While font categories are presented along the horizontal axis (x-axis) and are color coded, in some arrangements, font attributes may be represented along the horizontal axis and be color coded. In some arrangements the font categories may be resented along the vertical axis (y-axis) of a chart. Color bending may be employed to present the information in the chart 600; for example, color blending may be used for a single category (e.g., the colored vertical bar representing the Italian Old Style Serif font category 602), in a group of categories (e.g., categories 602, 604, and 606), all the font categories (e.g., blending from lighter colors at upper portions of chart to darker colors at the lower portions of the chart).

Within each of the categories, fonts are also separated based upon the similarity of the particular font to adjacent categories. For example, dash-line box 642 contains a number of data points that represent fonts within category 608 (Transitional Serif) and are located at a particular position along the y-axis (that represents the level of the Attention Grabbing attribute). The data points within the box 642 are horizontally separated along the x-axis based upon their similarity (or non-similarity) to the adjacent category 606 (Dutch Old Style Serif) and the other adjacent category 610 (Modern Serif). Other types of dimensions may be used to separate such data. As such, fonts more similar to an adjacent category are positioned closer to that category and fonts less similar to an adjacent category are positioned farther from the that category. As such, a similarity measure is used to separate fonts that reside in a particular category and reflect a similar level of the selected font attribute.

The interface 508 also allows similar fonts to be presented for review. Once the user selects a font with a pointing device (as indicated with graphic 636), the title 638 and sample 640 of the font is presented in the interface 508. Additionally, the user can select a radio button 644 (labeled “Similar Fonts”) to present fonts that have been identified as similar to the selected font. In this example, a list 646 of four similar fonts are revealed by presenting the title of each similar fonts and displaying the titles in their respective font. Finding a font of interest in the list 646, the user can select that list entry (with a pointing device), and the location of the graphic 636 is moved to a corresponding location on the chart 600 where the new font of interest is represented. By allowing an end user to explore such a vast number of fonts by using a single interface display, the user is less likely to become overwhelmed by the sheer number font possible of being selected. In this example, over 28,000 fonts are represented in the chart 600; however, even more could be represented.

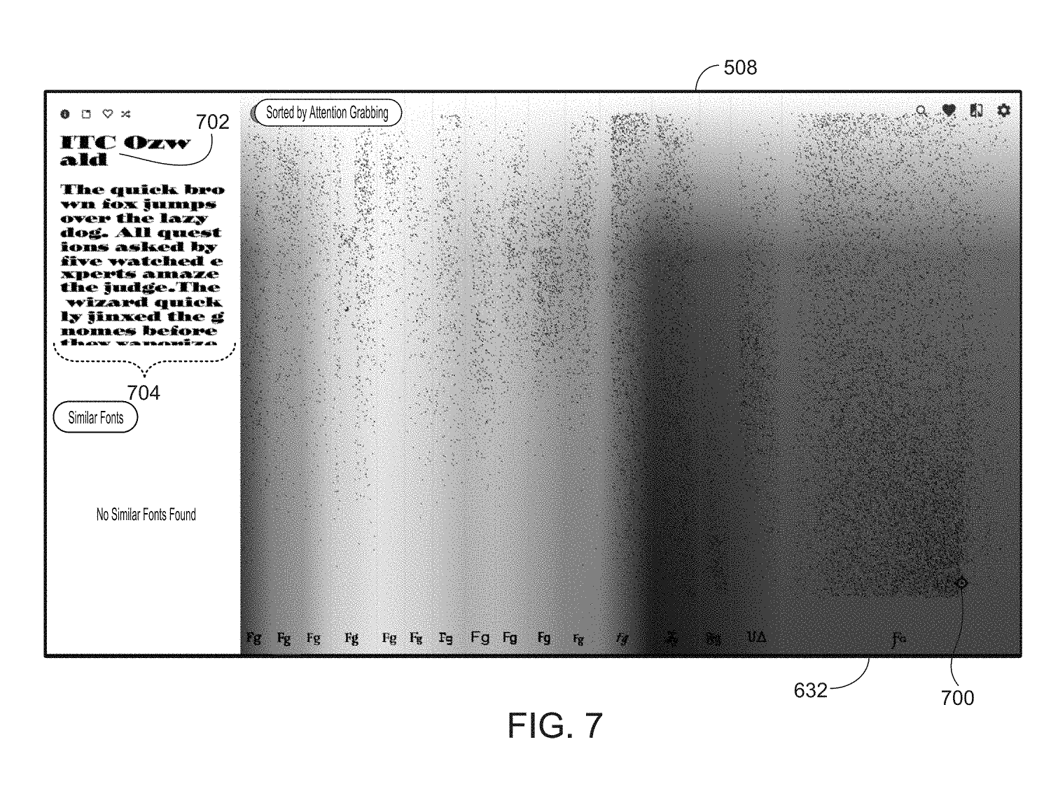

Referring to FIG. 7, the interface 508 is again presented, however a new font has been selected by the end user. As indicated by graphic 700, a font has been selected in the right-most presented category along the horizontal axis (i.e., the Display category 632). Compared to the font selected in FIG. 6, the newly selected font is located lower on the vertical axis and more prominently reflects the font attribute “Attention Grabbing” (selected by the end user). Similarly, the title of the selected font has changed to present a title 702 of the newly selected font, and a new sample 704 is presented that uses the newly selected font. As provided by both the title 702 and the sample 704, the newly selected font certainly reflects a more attention grabbing attribute compared to the font selection displayed in FIG. 6.

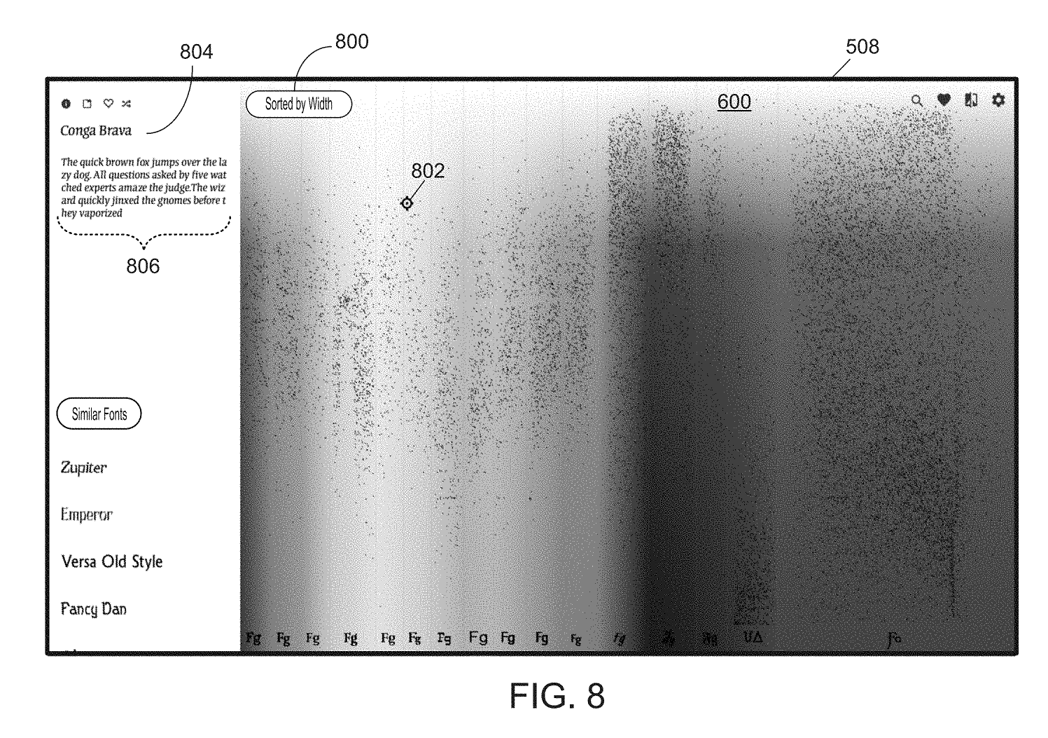

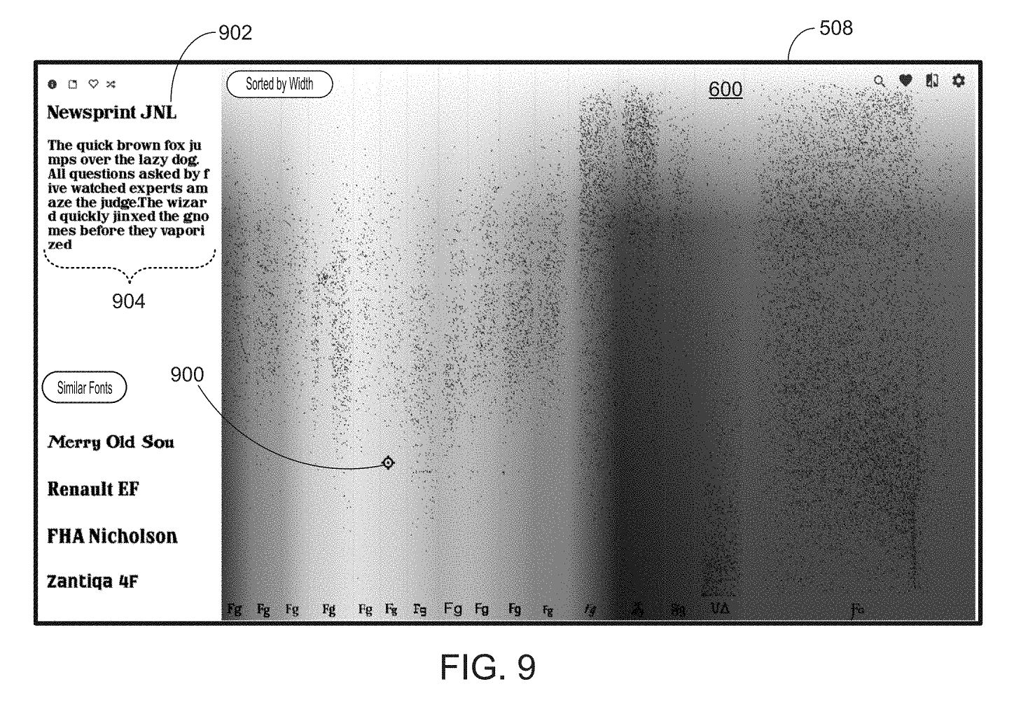

Referring to FIG. 8, by selecting a new font attribute, the presented vertical dimension of the chart changes and the data points representing all of the fonts are re-distributed for a new graphical representation. In this example, the font attribute is switched from “Attention Grabbing” (as shown in FIGS. 6 and 7) to “Width” as indicated by a label 800 positioned in the chart 600 of graphical interface 508. Additionally, a new font has been selected by the end user, as evidenced by a graphic 802. Being selected at a location towards the upper end of the y-axis, which now representing the font attribute “width”, the selected font does not overly reflect this attribute. As evidenced by the presented title 804 and text sample 806, the selected font does not include character segments with large widths. Referring to FIG. 9, in stark contrast a font that considerably reflects the new font attribute “Width” can quickly be identified by simply traversing downward in the same category and selecting a font a lower position along the y-axis. As demonstrated in this example, upon selecting a new font (as indicated by the graphic 900), a font title 902 and text sample 904 is presented in the interface 508 for which character segments have considerably thicker widths.

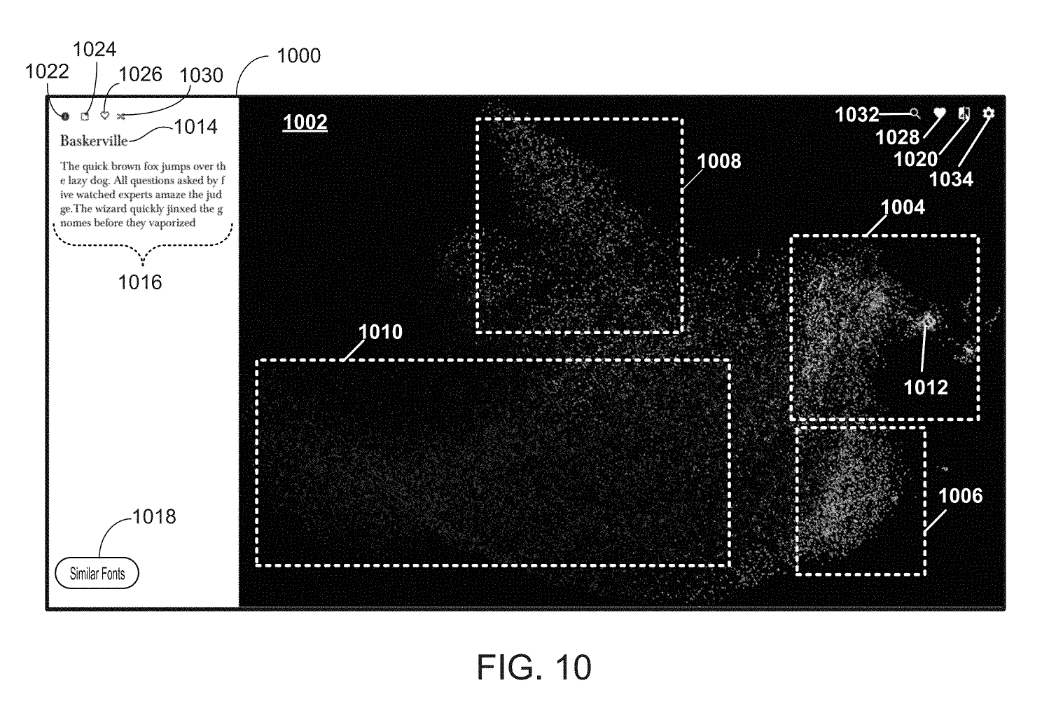

Referring to FIG. 10, other types of two- and three-dimensional representations may be created by the Font Space Graphic Engine 418 (shown in FIG. 4) to present data from the n-dimensional font space. Similar to the charts presented in FIGS. 5-9, colors may be used to potentially create a cognitive mapping between a color and a particular type of font. Forming such an association can draw the attention of the user (e.g., a designer) to a particular region of the graphical representation and quickly assist in recognizing fonts with similar characteristics. While the graphical representations of FIGS. 5-9 used a Cartesian coordinate system to graphically present the font information (e.g., using an x-axis, y-axis, and color), one or more other types of coordinate systems may be employed (e.g., a polar, cylindrical, etc. coordinate system). FIG. 10 presents another type of graphical representation that allows a viewer to investigate a vast number of fonts (e.g., 28,000 fonts), each being represented by a selectable data point. Each font is assigned an x and a y coordinate to position a data point (that represents the font) on the two-dimensional coordinate system. To assist the viewer, data points representing similar fonts are located nearby and data points representing dissimilar fonts are located more distant apart. Additionally, to further assist the viewer, a color is assigned to a data point that corresponds to the category that the font was assigned. For example, as shown in FIGS. 5-9, the following colors were assigned to the each font category: Italian Old Style Serif (Red), French Old Style Serif (Orange), Dutch Old Style Serif (Orange-Yellow), Transitional Serif (Yellow), Modern Serif (Bright Yellow), Clarendon Serif (Yellow-Green), Slab Serif (Green), Geometric Sans Serif (Green-Light Blue), Grotesque Sans Serif (Light Blue), Contemporary Humanist Sans Serif (Light Blue-Dark Blue), Humanist Sans Serif (Dark Blue), Informal Script (Dark Blue-Dark Purple), Formal Script (Dark Purple), Black Letter (Purple), Symbol (Purple-Violet), and Display (Violet).

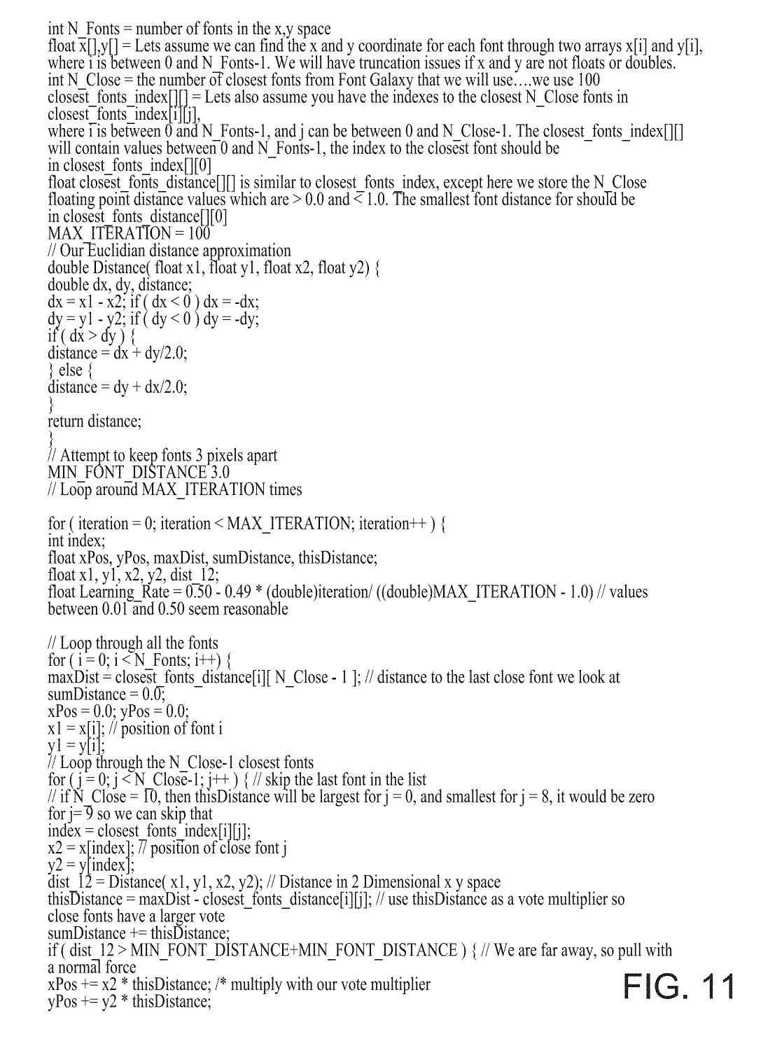

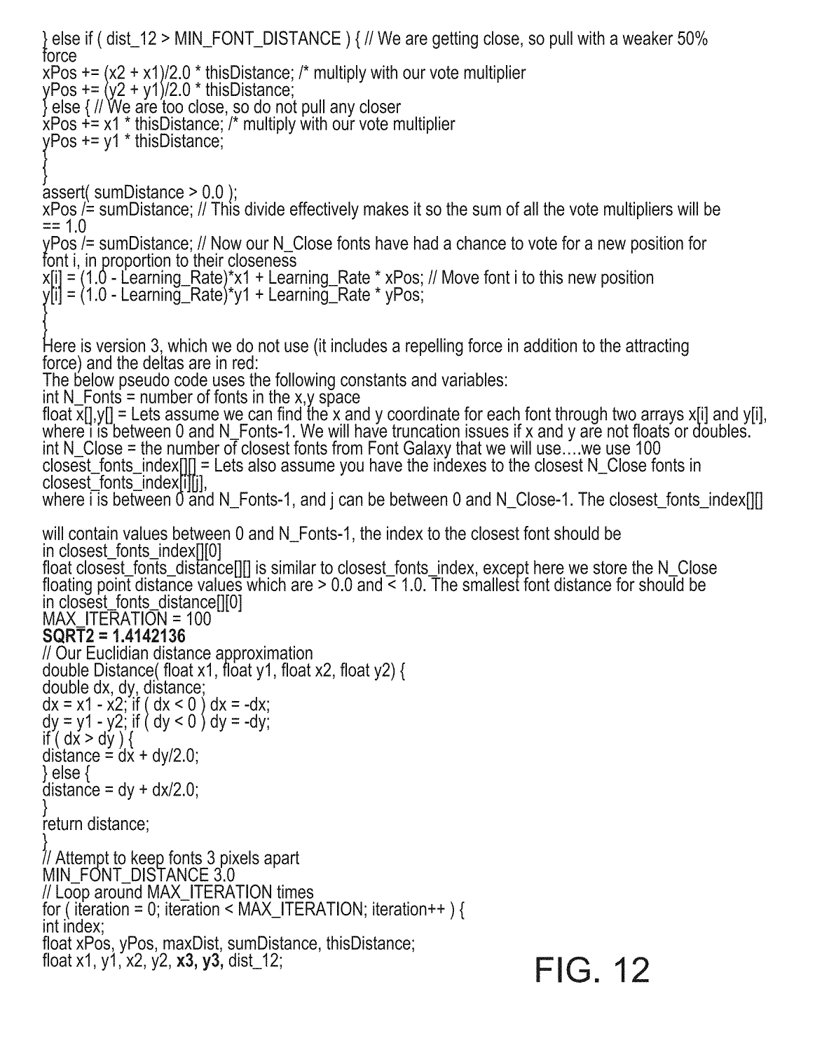

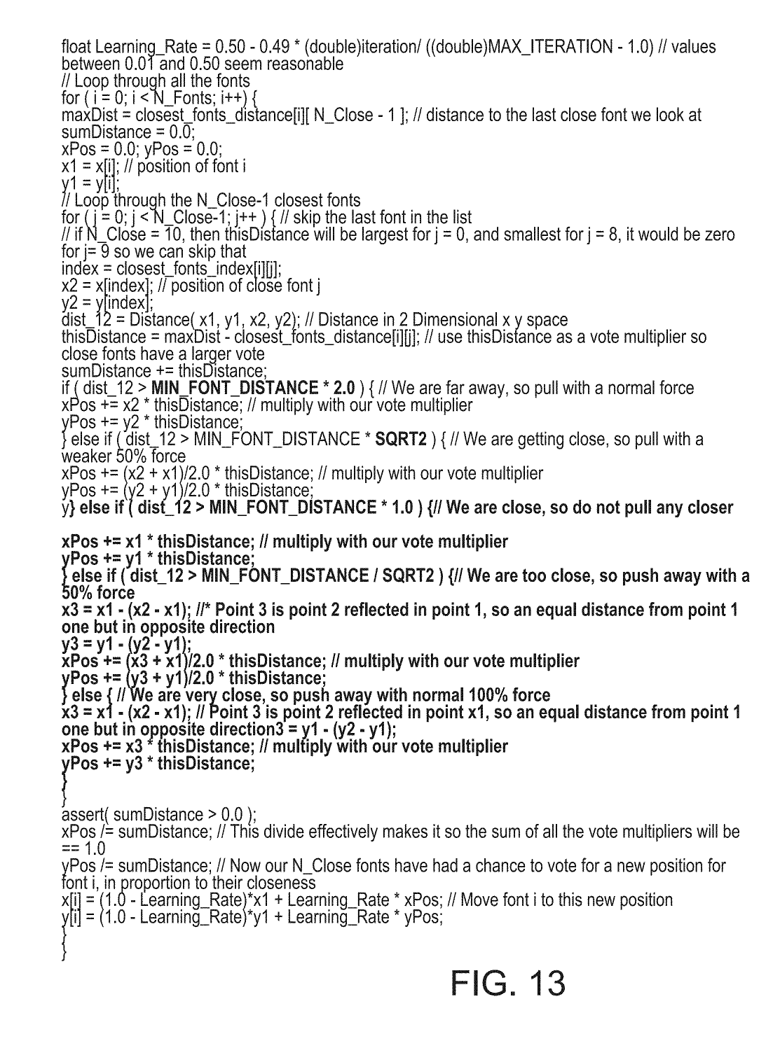

One or more techniques can be employed to graphically distribute the colored data points such that similar fonts are positioned closer and dissimilar fonts are more distant. For example, the Font Space Graphic Engine 418 may employ one or more dimensionality reduction processes. In one arrangement, a t-distributed stochastic neighbor embedding (t-SNE) process uses one or more machine learning techniques for dimensionality reduction. In general, t-SNE is a nonlinear dimensionality reduction technique that can embed high-dimensional data (e.g., n-dimensional font space information) into a space of two or three dimensions. Once embedded into the lower dimension space, that data can be visualized using one or more graphical techniques such as a scatter plot, as shown in the figure. The t-SNE technique models each high-dimensional object (e.g., a feature vector that represents a font) by a two- or three-dimensional point in such a way that similar objects are modeled by nearby points and dissimilar objects are modeled by distant points. Other dimensionality reductions processes may be used; for example, principal component analysis (PCA) may be employed. In still another example, FIGS. 11-13 present a listing of dimension reduction instructions for reducing an n-dimensional font space such that each font is represented by an x-axis and y-axis coordinate. For this example, the t-SNE process (using 512 features and a 34 layer Deep Residual Network) produce initial x and y coordinates for the fonts. The instructions presented in FIGS. 11-13, provide the final position coordinates for the fonts, and from which the distances between fonts are determined. However, other machine learning techniques, parameters, etc. may be employed in other arrangements.

Referring back to FIG. 10, a graphical interface 1000 includes a scatter plot 1002 that presents the colored data points that represent the individual fonts. In this example, the x-axis and y-axis of the scatter plot 1002 are based on the similarity between pairs of fonts. Further, the particular color assigned to each data point (in the scatter plot 1002) corresponds to the color of the particular category to which the font is a member. As provided by this color-coding of the data points, a number of distinct regions appear in the plot that correspond to the different types of fonts also present in the charts of FIG. 5-9. Data points colored red, yellow, and orange (highlighted by dashed-line box 1004) represent fonts in categories 602-612 (of the chart 508, shown in FIG. 6), data points including shades of green (highlighted by dashed-line box 1006) represent fonts in categories 612-616, data points colored blue (highlighted by dashed-line box 1008) represent fonts in categories 618-624, and data points colored in shades of purple (highlighted by dashed-box 1010) represent the fonts in categories 626-632. While the color-coded third dimension (the z-axis of the scatter plot 1002) represents the category of each font (as shown in FIGS. 5-9), the third dimension may represent other quantities such as attributes of the fonts.

Similar to interfaces presented in FIGS. 5-9, other types of functionality can be provided by the graphical interface 1000; for example, a viewer can select an individual data point (that corresponds to a particular font) to view information about the related font. In this arrangement, upon selecting a data point (with a pointing device), as indicated by graphic 1012, a graphical representation of a title 1014 of the selected font and sample text 1016 using the selected font are displayed in a portion of the interface 1000. Additionally, the view can select a radio button 1018 to present a list of fonts identified as being similar to the selected font (highlighted by the graphic 1012) as determined by the font presenter 320 (e.g., similarity being determined from feature vectors of the fonts, survey information, etc.), as described above.

Interface 1000, along with the interfaces presented in FIGS. 5-9 can provide other types of functionality to assist a viewer (e.g., a designer) in gathering information about particular fonts and potentially licensing the fonts from the font service provider 312. Along with allowing a viewer to toggle between multiple interfaces (e.g., toggle between interface 508 and interface 1000), data selected in one interface may be provided to another interface for presentation. For example, data representing that a font has been selected in interface 508 can be tracked such that the same font is shown selected in interface 1000 (e.g., when the viewer toggles to other interface). In the illustrated arrangement, a user-selectable icon 1020 toggles between the interfaces. Interface 1000, along with the interfaces in FIGS. 5-9, are also expandable and compressible to allow a viewer to “zoom in” and “zoom out” of the presented data representing the fonts. In some arrangements, the amount of fonts visually represented may change while zooming in and zooming out of the interfaces. For example, upon zooming in upon an interface, all of the fonts would be visually present in the interface. Alternatively, zooming out, a subset of the fonts may be visually represented. By zooming out, nearby data points visually appear too close for a viewer to now individually distinguish the data points. One or more techniques may be employed to determine which data points to present and which to not present (based on the viewer zooming out). For example, a predefined percentage of points (70%) may be presented. One or more rules may also be applied to determine which data points to present; for example, rules associated for presenting more frequently licenses fonts, positively trending fonts (e.g., font frequently view as determined from click data), etc. may be employed. Other types of rules may also be employed, for example, if the data points represent other types of items such as consumer products (e.g., a rule associated with presenting data points that represent the most frequently purchased shoes, etc.).

One or more icons can be included (in the interfaces) to select additional information for presentation; for example, along with a title and sample text using a font, a selected radio button 1022 may provide additional information about a selected font. A selectable icon 1024 may also be provided that initiates a connection to the font service provider 312; for example, upon selecting the icon 1024, a web browser page is presented to view information related to the selected font (e.g., information for attaining a license to the font). Given the vast number of fonts being presented to a viewer, the interface 1000 can include an icon 1026 to allow one or more “favorite” fonts to be stored for later use (e.g., selected to attain a license from the font service provider). Along with selecting the icon 1026 to store a particular font as a favorite, an icon 1028 is selectable to retrieve previously stored favorite fonts. In this arrangement, the viewer can select an icon 1030 that initiates the random selection of a font (in the font space) and positioning the graphic 1012 on the data point associated with the randomly selected font. The interface 1000 can also include a selectable icon 1032 that allows for a particular font to be searched and identified in the scatter plot (e.g., present a text box for the viewer to enter the name of a font, present a drop down menu with a searchable list of the represented fonts, etc.). The interface 1000 also includes an icon 1034 that initiates the presentation of a window that provides adjustable settings. Such settings can include adjusting visual characteristics (e.g., level of zoom) of the interface 1000, adjusting the percentage of fonts being presented in the scatter plot 1002 (e.g., presenting fonts based upon customer usage, license count, etc.), enable/disabling graphics that connect selected data points (e.g., currently selected fonts, previously selected fonts, etc.). Various other types of interface, graphics, etc. may be employed to present views of an n-dimensional font space to viewers to improve font searching, identification, selection, etc.

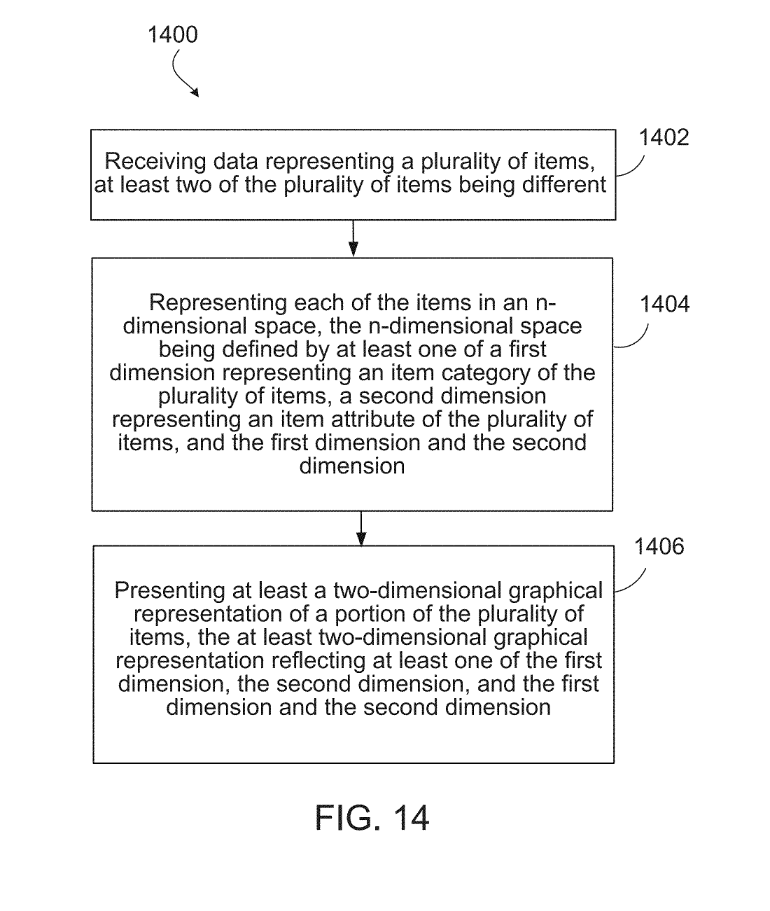

Referring to FIG. 14, a flowchart 1400 represents operations of a font presenter (e.g., the font presenter 320 shown in FIG. 3) being executed by a computing device (e.g., the server 318 located at the font service provider 312). Operations of the font presenter 320 are typically executed by a single computing device (e.g., the server 318); however, operations may be executed by multiple computing devices. Along with being executed at a single site (e.g., the font service provider 312), the execution of operations may be distributed among two or more locations. In some arrangements, a portion of the operations may be executed at a user device (e.g., the computing device 302), an intermediate computing device (e.g., located between a user device and the font service provider), one or more computing devices located external to the font service provider 312, etc.

Operations of the font presenter 320 may include receiving 1402 data representing a plurality of items, at least two items of the plurality of items being different. For example, data may be received that represents fonts, imagery (e.g., photographs, motion pictures, etc.), music, and other types of such content. Data may also be received that represents items that can be considered products (e.g., shoes, vehicles, etc.), services, etc. Operations may include representing each of the items in an n-dimensional space. The n-dimensional space being defined by at least a first dimension representing an item category of the plurality of items, a second dimension representing an item attribute of the plurality of items, or the first dimension and the second dimension. For example, font categories, font attributes, distances between font pairs, measures font similarities, etc. may be used to define one or more dimensions of an n-dimension font space. Operations may also include presenting at least a two-dimensional graphical representation of a portion of the plurality of items. The at least two-dimensional graphical representation reflecting at least one of the first dimension, the second dimension, and the first dimension and the second dimension. For example, as presented in FIGS. 5-9, a two dimensional chart may be presented in which the x-axis represents font categories and the y-axis presents numerical range associated with a font attribute.

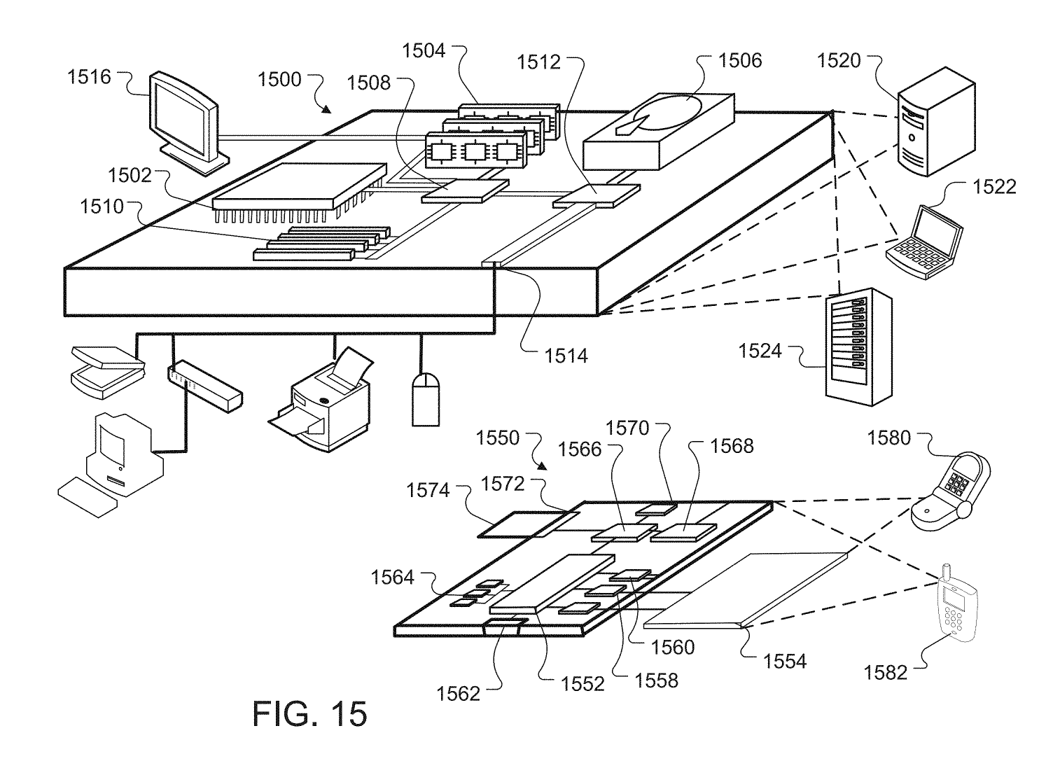

FIG. 15 shows an example of example computing device 1500 and example mobile computing device 1550, which can be used to implement the techniques described herein. For example, a portion or all of the operations of font presenter 320 (shown in FIG. 3) may be executed by the computing device 1500 and/or the mobile computing device 1550. Computing device 1500 is intended to represent various forms of digital computers, including, e.g., laptops, desktops, workstations, personal digital assistants, servers, blade servers, mainframes, and other appropriate computers. Computing device 1550 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 1500 includes processor 1502, memory 1504, storage device 1506, high-speed interface 1508 connecting to memory 1504 and high-speed expansion ports 1510, and low speed interface 1512 connecting to low speed bus 1514 and storage device 1506. Each of components 1502, 1504, 1506, 1508, 1510, and 1512, are interconnected using various busses, and can be mounted on a common motherboard or in other manners as appropriate. Processor 1502 can process instructions for execution within computing device 800, including instructions stored in memory 1504 or on storage device 1506 to display graphical data for a GUI on an external input/output device, including, e.g., display 1516 coupled to high speed interface 1508. In other implementations, multiple processors and/or multiple busses can be used, as appropriate, along with multiple memories and types of memory. Also, multiple computing devices 1500 can be connected, with each device providing portions of the necessary operations (e.g., as a server bank, a group of blade servers, or a multi-processor system).

Memory 1504 stores data within computing device 1500. In one implementation, memory 1504 is a volatile memory unit or units. In another implementation, memory 1504 is a non-volatile memory unit or units. Memory 1504 also can be another form of computer-readable medium (e.g., a magnetic or optical disk. Memory 1504 may be non-transitory.)

Storage device 1506 is capable of providing mass storage for computing device 1500. In one implementation, storage device 1506 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 1504, storage device 1506, memory on processor 1502, and the like.)

High-speed controller 1508 manages bandwidth-intensive operations for computing device 1500, while low speed controller 1512 manages lower bandwidth-intensive operations. Such allocation of functions is an example only. In one implementation, high-speed controller 1508 is coupled to memory 1504, display 1516 (e.g., through a graphics processor or accelerator), and to high-speed expansion ports 1510, which can accept various expansion cards (not shown). In the implementation, low-speed controller 1512 is coupled to storage device 1506 and low-speed expansion port 1514. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 1500 can be implemented in a number of different forms, as shown in the figure. For example, it can be implemented as standard server 1520, or multiple times in a group of such servers. It also can be implemented as part of rack server system 1524. In addition or as an alternative, it can be implemented in a personal computer (e.g., laptop computer 822.) In some examples, components from computing device 1500 can be combined with other components in a mobile device (not shown), e.g., device 1550. Each of such devices can contain one or more of computing device 1500, 1550, and an entire system can be made up of multiple computing devices 1500, 1550 communicating with each other.

Computing device 1550 includes processor 1552, memory 1564, an input/output device (e.g., display 1554, communication interface 1566, and transceiver 1568) among other components. Device 1550 also can be provided with a storage device, (e.g., a microdrive or other device) to provide additional storage. Each of components 1550, 1552, 1564, 1554, 1566, and 1568, are interconnected using various buses, and several of the components can be mounted on a common motherboard or in other manners as appropriate.

Processor 1552 can execute instructions within computing device 1550, including instructions stored in memory 1564. The processor can be implemented as a chipset of chips that include separate and multiple analog and digital processors. The processor can provide, for example, for coordination of the other components of device 1550, e.g., control of user interfaces, applications run by device 1550, and wireless communication by device 1550.

Processor 1552 can communicate with a user through control interface 1558 and display interface 1556 coupled to display 1554. Display 1554 can be, for example, a TFT LCD (Thin-Film-Transistor Liquid Crystal Display) or an OLED (Organic Light Emitting Diode) display, or other appropriate display technology. Display interface 1556 can comprise appropriate circuitry for driving display 1554 to present graphical and other data to a user. Control interface 1558 can receive commands from a user and convert them for submission to processor 1552. In addition, external interface 1562 can communicate with processor 1542, so as to enable near area communication of device 1550 with other devices. External interface 1562 can provide, for example, for wired communication in some implementations, or for wireless communication in other implementations, and multiple interfaces also can be used.

Memory 1564 stores data within computing device 1550. Memory 1564 can be implemented as one or more of a computer-readable medium or media, a volatile memory unit or units, or a non-volatile memory unit or units. Expansion memory 1574 also can be provided and connected to device 1550 through expansion interface 1572, which can include, for example, a SIMM (Single In Line Memory Module) card interface. Such expansion memory 1574 can provide extra storage space for device 1550, or also can store applications or other data for device 1550. Specifically, expansion memory 1574 can include instructions to carry out or supplement the processes described above, and can include secure data also. Thus, for example, expansion memory 1574 can be provided as a security module for device 1550, and can be programmed with instructions that permit secure use of device 1550. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 1564, expansion memory 1574, and/or memory on processor 1552), which can be received, for example, over transceiver 1568 or external interface 1562.

Device 1550 can communicate wirelessly through communication interface 1566, which can include digital signal processing circuitry where necessary. Communication interface 1566 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 1568. In addition, short-range communication can occur, e.g., using a Bluetooth®, WiFi, or other such transceiver (not shown). In addition, GPS (Global Positioning System) receiver module 1570 can provide additional navigation- and location-related wireless data to device 1550, which can be used as appropriate by applications running on device 1550. Sensors and modules such as cameras, microphones, compasses, accelerators (for orientation sensing), etc. may be included in the device.

Device 1550 also can communicate audibly using audio codec 1560, which can receive spoken data from a user and convert it to usable digital data. Audio codec 1560 can likewise generate audible sound for a user, (e.g., through a speaker in a handset of device 1550.) Such sound can include sound from voice telephone calls, can include recorded sound (e.g., voice messages, music files, and the like) and also can include sound generated by applications operating on device 1550.

Computing device 1550 can be implemented in a number of different forms, as shown in the figure. For example, it can be implemented as cellular telephone 1580. It also can be implemented as part of smartphone 1582, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
receiving data representing a plurality of items, at least two items of the plurality of items being different;
representing each of the items in an n-dimensional space, the n-dimensional space being defined by at least one of a first dimension representing an item category of the plurality of items, a second dimension representing an item attribute of the plurality of items, and the first dimension and the second dimension; and
presenting at least a two-dimensional graphical representation of a portion of the plurality of items, the at least two-dimensional graphical representation reflecting at least one of the first dimension, the second dimension, and the first dimension and the second dimension.

2. The computing device implemented method of claim 1, wherein the n-dimensional space is defined by a third dimension representing similarity of pairs of items included in the plurality of items.

3. The computing device implemented method of claim 2, wherein color is used to reflect at least one of the first dimension, the second dimension, and the first dimension and the second dimension in the at least two-dimensional graphical representation.

4. The computing device implemented method of claim 1, wherein the plurality of items is a plurality of fonts.

5. The computing device implemented method of claim 1, wherein the plurality of items is a plurality of products.

6. The computing device implemented method of claim 2, wherein the similarity of the pairs of items is determined from item features and survey data.

7. The computing device implemented method of claim 1, wherein the item category of the plurality of items is determined by machine learning.

8. The computing device implemented method of claim 1, wherein the item attribute of the plurality of items is determined by machine learning.

9. The computing device implemented method of claim 1, wherein a dimensionality reduction process is used to present the two-dimensional graphical representation of the portion of the plurality of items.

10. The computing device implemented method of claim 2, wherein the first dimension and the third dimension are represented in the two-dimensional graphical representation, the third dimension being represented in color.

11. The computing device implemented method of claim 1, wherein the first dimension and the second dimension are represented in the two-dimensional graphical representation, the first dimension being represented in color.

12. The computing device implemented method of claim 1, wherein the two-dimensional graphical representation is visually expandable.

13. The computing device implemented method of claim 1, wherein the portion of the plurality of items includes all of the plurality of items based on the two-dimensional graphical representation being visually expanded.

14. The computing device implemented method of claim 1, wherein the portion of the plurality of items includes a subset of the plurality of items based on the two-dimensional graphical representation being visually compressed.

15. The computing device implemented method of claim 14, wherein the subset of the plurality of items includes items most frequently requested from users.

16. A system comprising:
a computing device comprising:
a memory configured to store instructions; and
a processor to execute the instructions to perform operations comprising:
receiving data representing a plurality of items, at least two items of the plurality of items being different;
representing each of the items in an n-dimensional space, the n-dimensional space being defined by at least one of a first dimension representing an item category of the plurality of items, a second dimension representing an item attribute of the plurality of items, and the first dimension and the second dimension; and
presenting at least a two-dimensional graphical representation of a portion of the plurality of items, the at least two-dimensional graphical representation reflecting at least one of the first dimension, the second dimension, and the first dimension and the second dimension.

17. The system of claim 16, wherein the n-dimensional space is defined by a third dimension representing similarity of pairs of items included in the plurality of items.

18. The system of claim 17, wherein color is used to reflect at least one of the first dimension, the second dimension, and the first dimension and the second dimension in the at least two-dimensional graphical representation.

19. The system of claim 16, wherein the plurality of items is a plurality of fonts.

20. The system of claim 16, wherein the plurality of items is a plurality of products.

21. The system of claim 17, wherein the similarity of the pairs of items is determined from item features and survey data.

22. The system of claim 16, wherein the item category of the plurality of items is determined by machine learning.

23. The system of claim 16, wherein the item attribute of the plurality of items is determined by machine learning.

24. The system of claim 16, wherein a dimensionality reduction process is used to present the two-dimensional graphical representation of the portion of the plurality of items.

25. The system of claim 17, wherein the first dimension and the third dimension are represented in the two-dimensional graphical representation, the third dimension being represented in color.

26. The system of claim 16, wherein the first dimension and the second dimension are represented in the two-dimensional graphical representation, the first dimension being represented in color.

27. The system of claim 16, wherein the two-dimensional graphical representation is visually expandable.

28. The system of claim 16, wherein the portion of the plurality of items includes all of the plurality of items based on the two-dimensional graphical representation being visually expanded.

29. The system of claim 16, wherein the portion of the plurality of items includes a subset of the plurality of items based on the two-dimensional graphical representation being visually compressed.

30. The system of claim 29, wherein the subset of the plurality of items includes items most frequently requested from users.

31. One or more computer readable media storing instructions that are executable by a processing device, and upon such execution cause the processing device to perform operations comprising:
receiving data representing a plurality of items, at least two items of the plurality of items being different;
representing each of the items in an n-dimensional space, the n-dimensional space being defined by at least one of a first dimension representing an item category of the plurality of items, a second dimension representing an item attribute of the plurality of items, and the first dimension and the second dimension; and
presenting at least a two-dimensional graphical representation of a portion of the plurality of items, the at least two-dimensional graphical representation reflecting at least one of the first dimension, the second dimension, and the first dimension and the second dimension.

32. The computer readable media of claim 31, wherein the n-dimensional space is defined by a third dimension representing similarity of pairs of items included in the plurality of items.

33. The computer readable media of claim 32, wherein color is used to reflect at least one of the first dimension, the second dimension, and the first dimension and the second dimension in the at least two-dimensional graphical representation.

34. The computer readable media of claim 31, wherein the plurality of items is a plurality of fonts.

35. The computer readable media of claim 31, wherein the plurality of items is a plurality of products.

36. The computer readable media of claim 32, wherein the similarity of the pairs of items is determined from item features and survey data.

37. The computer readable media of claim 31, wherein the item category of the plurality of items is determined by machine learning.

38. The computer readable media of claim 31, wherein the item attribute of the plurality of items is determined by machine learning.

39. The computer readable media of claim 31, wherein a dimensionality reduction process is used to present the two-dimensional graphical representation of the portion of the plurality of items.

40. The computer readable media of claim 32, wherein the first dimension and the third dimension are represented in the two-dimensional graphical representation, the third dimension being represented in color.

41. The computer readable media of claim 31, wherein the first dimension and the second dimension are represented in the two-dimensional graphical representation, the first dimension being represented in color.

42. The computer readable media of claim 31, wherein the two-dimensional graphical representation is visually expandable.

43. The computer readable media of claim 33, wherein the portion of the plurality of items includes all of the plurality of items based on the two-dimensional graphical representation being visually expanded.

44. The computer readable media of claim 31, wherein the portion of the plurality of items includes a subset of the plurality of items based on the two-dimensional graphical representation being visually compressed.

45. The computer readable media of claim 44, wherein the subset of the plurality of items includes items most frequently requested from users.
